(19) United States
(12) Patent Application Publication
(10) Pub. No.: US 2015/0318740 A1
(43) Pub. Date: Nov. 5, 2015

(54) ELECTROMAGNETIC ENERGY TRANSFER USING TUNABLE INDUCTORS

(71) Applicant: LSI Corporation, San Jose, CA (US)

(72) Inventor: Roger A. Fratti, Mohnton, PA (US)

(73) Assignee: LSI Corporation, San Jose, CA (US)

(21) Appl. No.: 14/288,363

(22) Filed: May 27, 2014

Related U.S. Application Data
(60) Provisional application No. 61/986,569, filed on Apr. 30, 2014.

(51) Int. Cl. H02J 17/00; H02J 5/00; H02J 7/02

(52) U.S. Cl. CPC H02J 17/00; H02J 7/025; H02J 5/005

(57) ABSTRACT

A receiving coil apparatus for use in an electromagnetic energy transfer system includes multiple conductive loops and a switching circuit connected with the conductive loops. The switching circuit is configured to control an electrical center of the receiving coil apparatus as a function of at least one control signal. A controller connected with the switching circuit is configured to generate the control signal for controlling an alignment of the electrical center of the receiving coil apparatus with an electromagnetic field so as to enhance an amount of energy transferred to the receiving coil apparatus from the electromagnetic field.

### CROSS-REFERENCE TO RELATED APPLICATION(S)

This application claims the benefit of U.S. Provisional Patent Application No. 61/986,569 filed on Apr. 30, 2014, the complete disclosure of which is expressly incorporated by reference herein in its entirety for all purposes.

### FIELD OF THE INVENTION

The present invention relates generally to electrical and electronic circuitry, and more particularly relates to wireless power transfer.

### BACKGROUND

The general concept of wireless energy transfer has been known for over one hundred years. Electromagnetic (EM) energy transfer in the form of inductive power technology involves the wireless transmission of electrical energy from a power source, for example, an inductive charger, to an electrical load, for example, an inductive receiver. Two basic forms of EM energy transfer include near-field transfer and far-field transfer. Based on principles of EM coupling, near-field transfer employs a transmitter coil to generate an alternating current EM field, while a receiver coil placed within prescribed dimensions of the transmitter coil receives energy from the EM field and converts it back into an electrical current. Many consumer products use near-field inductive chargers to power and/or charge portable devices. Specialized medical and all-weather applications, for example, are also well-suited to exploit the advantages of inductive charging technology.

One problem with EM energy transfer using two coils is that energy transfer efficiency decreases significantly as a distance between the coils increases or when the coils are not precisely aligned.

### SUMMARY

In accordance with an embodiment of the invention, a receiving coil apparatus for use in an EM energy transfer system includes multiple conductive loops and a switching circuit connected with the conductive loops. The switching circuit is configured to control an electrical center of the receiving coil apparatus as a function of at least one control signal. A controller connected with the switching circuit is configured to generate the control signal for controlling an alignment of the electrical center of the receiving coil apparatus relative to an EM field so as to enhance an amount of energy transferred to the receiving coil apparatus from the EM field. Other embodiments of the invention include, but are not limited to, being manifest as at least a portion of an integrated circuit, as a method for enhancing energy transfer performance in an EM energy transfer system, and as an electronic system (e.g., a wireless charging system). Additional and/or other embodiments of the invention are described in the following written description, including the claims, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 conceptually depicts a basic principle of inductive charging;

FIG. 2 is a schematic diagram depicting at least a portion of an illustrative inductive charging system 200 in which one or more embodiments of the invention can be implemented;

FIG. 3 conceptually depicts at least a portion of an exemplary receiving coil suitable for use in an EM energy transfer system according to an embodiment of the invention;

FIGS. 4A-4C conceptually depict at least a portion of an exemplary receiving coil including switching circuitry, for controlling an electrical center of the coil, operative in three different modes, according to an embodiment of the invention;

FIG. 5 is a schematic diagram depicting at least a portion of exemplary switching circuitry for implementing each of at least a subset of the switches shown in FIGS. 4A-4C, according to an embodiment of the invention;

FIG. 6 is a schematic diagram depicting at least a portion of an exemplary wireless inductive power system, according to an embodiment of the invention;

FIG. 7 is a flow diagram depicting an exemplary methodology for configuring at least a subset of switches in a receiving coil, according to an embodiment of the invention; and

FIG. 8 is a block diagram depicting an exemplary processing device suitable for implementing at least a portion of the illustrative controller shown in FIG. 6, according to an embodiment of the invention.

It is to be appreciated that the drawings described herein are presented for illustrative purposes only. Moreover, common but well-understood elements and/or features that may be useful or necessary in a commercially feasible embodiment may not be shown in order to facilitate a less hindered view of the illustrated embodiments.

### Written Description

Embodiments of the invention will be described herein in the context of illustrative electromagnetic (EM) charging circuits having tunable receiving (i.e., pickup) coils. It should be understood, however, that embodiments of the invention are not limited to these or any other particular circuit arrangements or applications. Rather, embodiments of the invention are more broadly applicable to techniques for facilitating alignment of a receiving coil with a corresponding transmitting coil in the EM energy transfer system. In this manner, embodiments of the invention provide enhanced efficiency of EM energy transfer in the EM energy transfer system. Moreover, it will become apparent to those skilled in the art given the teachings herein that numerous modifications can be made to the illustrative embodiments shown that are within the scope of the claimed invention. That is, no limitations with respect to the embodiments shown and described herein are intended or should be inferred.

As a preliminary matter, for purposes of clarifying and describing embodiments of the invention, the following table provides a summary of certain acronyms and their corresponding definitions, as the terms are used herein:

Table of Acronym Definitions

| Acronym | Definition |
|---|---|
| EM | Electromagnetic |
| MISFET | Metal-insulator-semiconductor field-effect transistor |
| MOSFET | Metal-oxide-semiconductor field-effect transistor |
| FET | Field-effect transistor |
| NFET | N-channel field-effect transistor |
| NMOS | N-channel metal-oxide-semiconductor |
| PFET | P-channel field-effect transistor |
| PMOS | P-channel metal-oxide-semiconductor |
| CMOS | Complementary metal-oxide-semiconductor |
| MOS | Metal-oxide-semiconductor |
| BJT | Bipolar junction transistor |
| AC | Alternating current |
| DC | Direct current |
| SPDT | Single pole double throw |

Throughout the description herein, the term MISFET is intended to be construed broadly and to encompass any type of metal-insulator-semiconductor field-effect transistor. The term MISFET is, for example, intended to encompass semiconductor field-effect transistors (FETs) that utilize an oxide material as their gate dielectric, as in the case of metal-oxide-semiconductor field-effect transistors (MOSFETs), as well as those that do not. In addition, despite a reference to the term “metal” in the acronym MISFET, the term MISFET is intended to encompass semiconductor field-effect transistors wherein the gate is formed from a non-metal, such as, for instance, polysilicon.

Although embodiments of the invention described herein may be implemented using p-channel MISFETs (hereinafter called “PFETs” or “PMOS” devices) and/or n-channel MISFETs (hereinafter called “NFETs” or “NMOS” devices), as may be formed using a complementary metal-oxide-semiconductor (CMOS) fabrication process, it is to be appreciated that embodiments of the invention are not limited to such transistor devices and/or such a fabrication process, and that other suitable devices, such as, for example, bipolar junction transistors (BJTs), FinFETs, etc., and/or fabrication processes (e.g., bipolar, BiCMOS, etc.), may be similarly employed, as will be understood by those skilled in the art. Moreover, although embodiments of the invention are typically fabricated on a silicon wafer, embodiments of the invention can alternatively be fabricated in wafers comprising other materials or structures, including but not limited to gallium arsenide (GaAs), indium phosphide (InP), silicon-on-insulator (SOI), etc.

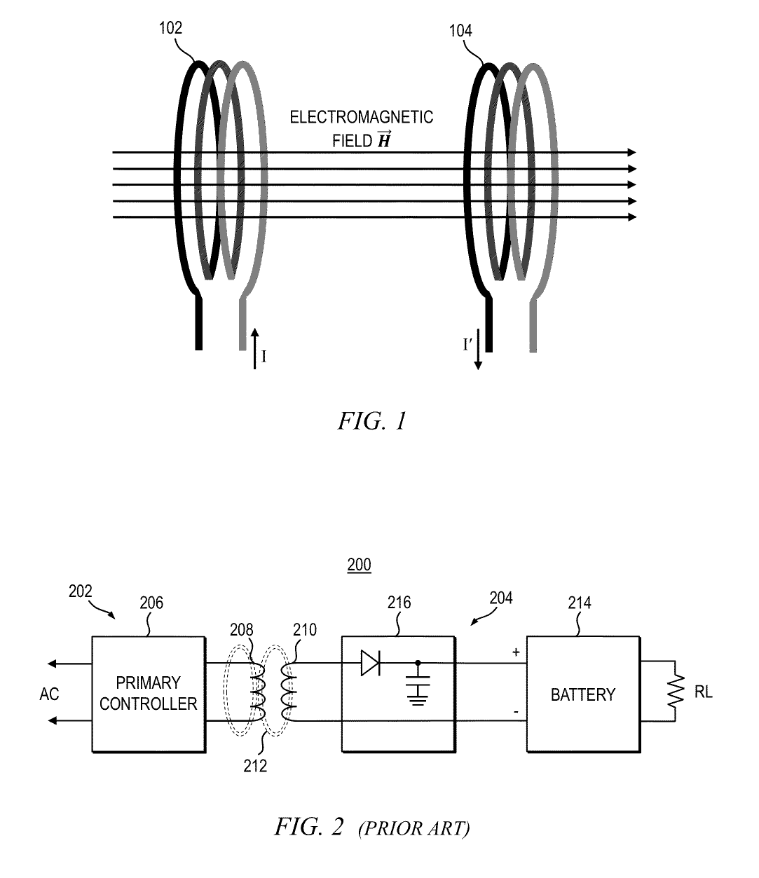

FIG. 1 conceptually depicts the basic principle of inductive charging. Inductive charging (i.e., wireless charging), an application of EM energy transfer, uses an EM field to transfer energy between two or more devices through an inductive coupling between the devices. To accomplish this, induction chargers pass an alternating current (AC), I, through a transmitting coil 102, also known as a charging coil, to thereby create an alternating EM field, \vec{H}, (e.g., from within a charging base station or other power source). The terms “B field” and “H field” are often used synonymously when referring to a magnetic field. As known by those skilled in the art, the H field represents magnetic field strength, measured in units of amps per meter (A/m); in free space or air, the B field represents magnetic flux density, given in units of Telsa by B=μ₀H, where μ₀ is the absolute magnetic permeability of free space.

A magnitude and direction of the resulting EM field \vec{H} will be a function of a magnitude and direction, respectively, of the current I supplied to the transmitting coil 102. For a straight wire conductor, using the right-hand rule, when the thumb is pointed in a direction of current flow through the wire, the fingers will curl in the direction of the resulting EM field around the wire. Likewise, for a closed loop conductor (e.g., a coil), when the fingers are curled in a direction of current flow around the loop, the thumb will point in a direction of the EM field through an electrical center of the conductive loop.

A receiving coil 104, also known as a pickup coil, (e.g., residing in a device being powered or charged) placed in proximity to the EM field \vec{H} receives energy from the EM field and converts it back into an electrical current I′ to power and/or the device. In essence, the two induction coils in proximity combine to form an electrical transformer. A magnitude of the current I′ induced in the receiving coil 104 will depend upon various factors, including energy transfer efficiency (which is a function of magnetic permeability between the two coils) and a ratio of the number of turns of wire between the transmitting and receiving coils. Greater distances between transmitting and receiving coils can be achieved when the inductive charging system uses resonant inductive coupling, although a problem exists of how to match the resonant frequencies of the two coils.

The induced current I′, which is an AC current, can be rectified and converted into a direct current (DC) for charging a battery, for example, of a portable device. By way of example only and without limitation, FIG. 2 is a schematic diagram depicting at least a portion of an illustrative inductive charging system 200 in which one or more embodiments of the invention can be implemented. With reference to FIG. 2, the inductive charging system 200 includes a primary side or base device 202 and a secondary side or portable device 204. A primary controller 206 of the base device 202, which would be well known to those skilled in the art, is connected to an AC power source and to a transmitting (i.e., primary) coil 208. The transmitting coil 208 is shown inductively coupled to a receiving (i.e., secondary) coil 210 by EM field 212. The receiving coil 210 is coupled with a battery 214, supplying power to the portable device 204, through a rectifier circuit 216. The battery, in turn, is coupled with a load RL. The rectifier circuit 216 converts an induced AC current, received from the receiving coil 210, into a DC current for charging the battery 214.

One problem exhibited by most EM energy transfer systems involves misalignment of the receiving coil with the transmitting coil, which decreases an efficiency of the EM energy transferred to the receiving coil from the EM field. Rather than using an arrangement that requires the receiving coil to be specifically designed to engage with the transmitting coil (e.g., in a so-called “lock and key” arrangement), as proposed by some conventional solutions (see, e.g., U.S. Pat. No. 5,952,814), embodiments of the present invention utilize a tunable receiving coil.

In accordance with one or more embodiments of the invention, a receiving coil apparatus for use, for example, in an EM charging application, is configured having multiple conductive loops, switching circuitry connected with the conductive loops, and a controller connected with the switching circuitry. As will be described in further detail below, the switching circuitry is adapted to selectively steer a current flowing in at least a subset of the conductive loops as a function of at least one control signal generated by the controller. By steering the current in the conductive loops, an electrical center of the receiving coil apparatus can be effectively “tuned” for enhanced EM energy transfer. The term enhanced as used herein is intended to refer broadly to an increase in energy transfer efficiency and/or amount (e.g., relative to a prescribed energy transfer efficiency and/or amount, or relative to an amount of energy transferred without using the novel current steering mechanism according to one or more embodiments of the invention), and may include, for example, maximizing or optimizing an amount of energy transferred via the receiving coil apparatus.

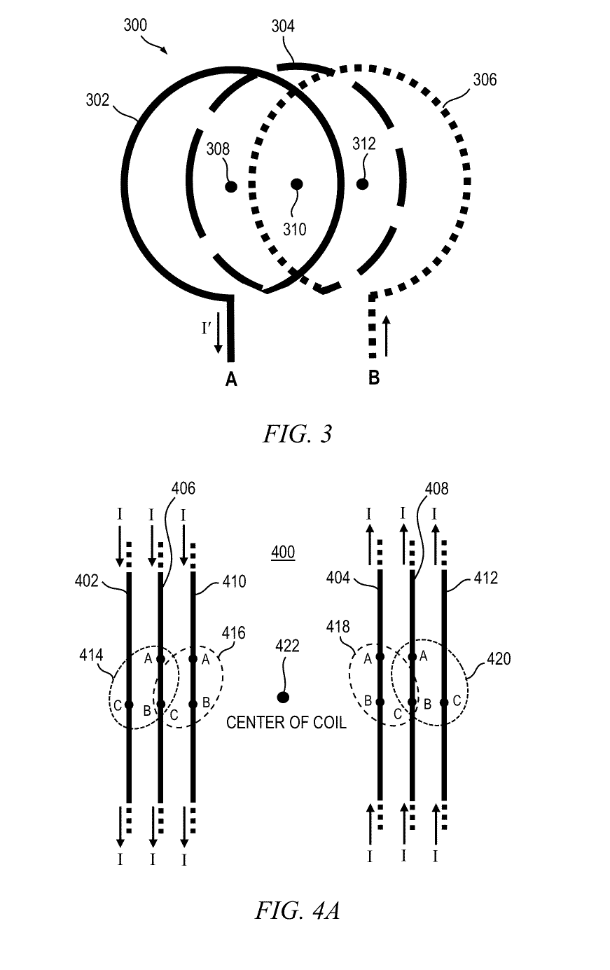

FIG. 3 conceptually depicts at least a portion of an exemplary receiving coil 300 suitable for use in an EM energy transfer system according to an embodiment of the invention. As apparent from FIG. 3, the receiving coil 300 includes a first conductive loop (i.e., coil) 302, a second conductive loop 304 and a third conductive loop 306 connected together in series between two nodes, A and B. Since, in this embodiment, all of the conductive loops 302, 304 and 306 are connected in series, a current, I′, flowing between nodes A and B will flow through each loop.

As will be known by those skilled in the art, electric current in a circular loop creates an EM field which is more concentrated in a center of the loop than outside the loop. Stacking multiple loops concentrates the field even more into what is called a solenoid. In a special case of symmetry, wherein a distance between a field point and any point along a circumference of the conductive loop is constant, the field contributions of all points along the circumference of the loop add directly at what is referred to herein as an electrical center of the loop. With reference to FIG. 3, point 308 represents an electrical center of the first conductive loop 302, point 310 represents an electrical center of the second conductive loop 304, and point 312 represents an electrical center of the third conductive loop 306. Thus, for example, when a current I′ is flowing through loop 302 in a counter-clockwise direction (as shown), a maximum EM field will be exhibited coming out of the page at point 308, in accordance with the right-hand rule. It is to be appreciated that in FIG. 3, the distances between the respective conductive loops and their corresponding electrical centers are not necessarily drawn to scale, but rather have been exaggerated for clarity.

When there are multiple conductive loops, as for the illustrative receiving coil 300 shown in FIG. 3, the respective EM field contributions of the loops 302, 304 and 306 are combined, using vector summation (i.e., magnitude and direction), to form an electrical center of the receiving coil where the EM field is a maximum. Assuming the current in all loops 302, 304 and 306 to be the same, and assuming symmetry (e.g., equal distance separating the loops), an electrical center of the EM field associated with the receiving coil 300 will be at about point 310. If, by way of example only and without limitation, a higher amount of current is made to flow through loop 302 compared to loop 306, an imbalance would be generated which would tend to shift the center of the EM field left, towards point 308. Embodiments of the present invention exploit this current shifting principle to selectively “tune” (i.e., control) a center of the receiving coil for providing more efficient energy transfer from the EM field generated by a transmitting coil.

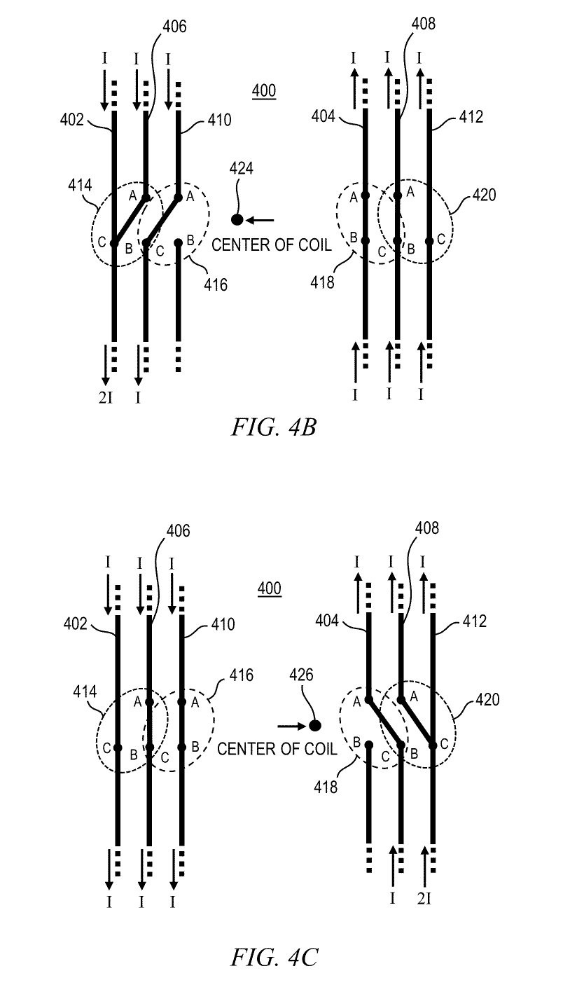

In accordance with one or more embodiments of the invention, the switching circuitry employed by the receiving coil apparatus comprises a plurality of switches, each switch (or subset of switches) being coupled in series with a corresponding one of the conductive loops. By way of example only and without limitation, FIGS. 4A through 4C depict at least a portion of an exemplary receiving coil 400 including three conductive loops (only a portion of which is shown); namely, a first loop comprising conductive segments 402 and 404, a second loop comprising conductive segments 406 and 408, and a third loop comprising conductive segments 410 and 412. It is to be understood that embodiments of the invention are not limited to any specific number of conductive loops. Each of the conductive loops includes a pair of switches, represented conceptually as a single pole double throw (SPDT) switch, although embodiments of the invention contemplate numerous implementations of the switching circuitry.

Specifically, with reference to FIGS. 4A through 4C, a first switch 414 is configured having a first node (A) connected with an upper portion of conductive segment 406, a second node (B) connected with a lower portion of segment 406, and a third node (C) connected with conductive segment 402. A second switch 416 is configured having a first node (A) connected with an upper portion of conductive segment 410, a second node (B) connected with a lower portion of segment 410, and a third node (C) connected with conductive segment 406. The third node of switch 416 and the second node of switch 414, in this embodiment, share the same connection point on segment 406. Likewise, a third switch 418 is configured having a first node (A) connected with an upper portion of conductive segment 404, a second node (B) connected with a lower portion of segment 404, and a third node (C) connected with conductive segment 408. A fourth switch 420 is configured having a first node (A) connected with an upper portion of conductive segment 408, a second node (B) connected with a lower portion of segment 408, and a third node (C) connected with conductive segment 412. The third node of switch 418 and the second node of switch 420, in this embodiment, share the same connection point on segment 408.

With reference to FIG. 4A, the receiving coil 400 is shown with each of the switches 414, 416, 418 and 420 operative in a first mode. In the first mode of operation of a given SPDT switch, node A, which represents a “common” terminal of the switch, is electrically connected with node B, which represents a “normally closed” terminal of the switch, and node C of the switch, which represents a “normally open” terminal of the switch, is electrically disconnected from either of nodes A or B. This may be considered a default mode of operation of the receiving coil 400. In this mode, an electrical center of the receiving coil 400 is represented by a point 422, which is essentially the same as if the receiving coil had no switching circuitry present (i.e., a standard receiving coil). Thus, each of the conductive segments 402, 404, 406, 408, 410 and 412 will have the same current, I, flowing therein.

With reference to FIG. 4B, the receiving coil 400 is shown with a first subset of the switches, 418 and 420, operative in the first mode and a second subset of the switches, 414 and 416, operative in a second mode. In the second mode of operation of a given SPDT switch, node A, which represents the “common” terminal of the switch, is electrically connected with node C, which represents the “normally open” terminal of the switch, and node B of the switch, which represents the “normally closed” terminal of the switch, is electrically disconnected from either of nodes A or C. With the switches configured in this arrangement, there will be no current flowing in the lower portion of conductive segment 410, while the same current, I, will flow through the upper and lower portions of segment 406 and twice the current, 2I, will flow through the lower portion of segment 402. Hence, the outer loop comprising conductive segment 402 will have a higher current density (2I) compared to the inner loop comprising conductive segment 410 (which will have no current flowing therein). This steering of current to the outer left loop will create a left shift of the electrical center of the receiving coil 400 to point 424, compared to the default mode, and is therefore considered a left shift mode of operation of the receiving coil 400.

Similarly, FIG. 4C depicts the receiving coil 400 with the second subset of switches, 414 and 416, operative in the first mode and the first subset of switches, 418 and 420, operative in the second mode. With the switches configured in this manner, there will be no current flowing in the lower portion of conductive segment 404, while the same current, I, will flow through the upper and lower portions of segment 408 and twice the current, 2I, will flow through the lower portion of segment 412. Hence, the outer loop comprising conductive segment 412 will have a higher current density (2I) compared to the inner loop comprising conductive segment 404 (which will have no current flowing therein). This steering of current to the outer right loop will create a right shift of the electrical center of the receiving coil 400 to point 426, compared to the default mode, and is therefore considered a right shift mode of operation of the receiving coil 400.

It is to be understood that embodiments of the invention are not limited to any particular configuration of the switching circuitry. For example, each conductive loop need not have a corresponding switch, and therefore the number of switches employed may be less than the number of conductive segments in a given receiving coil. Furthermore, although depicted conceptually as mechanical SPDT switches, the switching circuitry, in one or more embodiments, is implemented using one or more transmission gates.

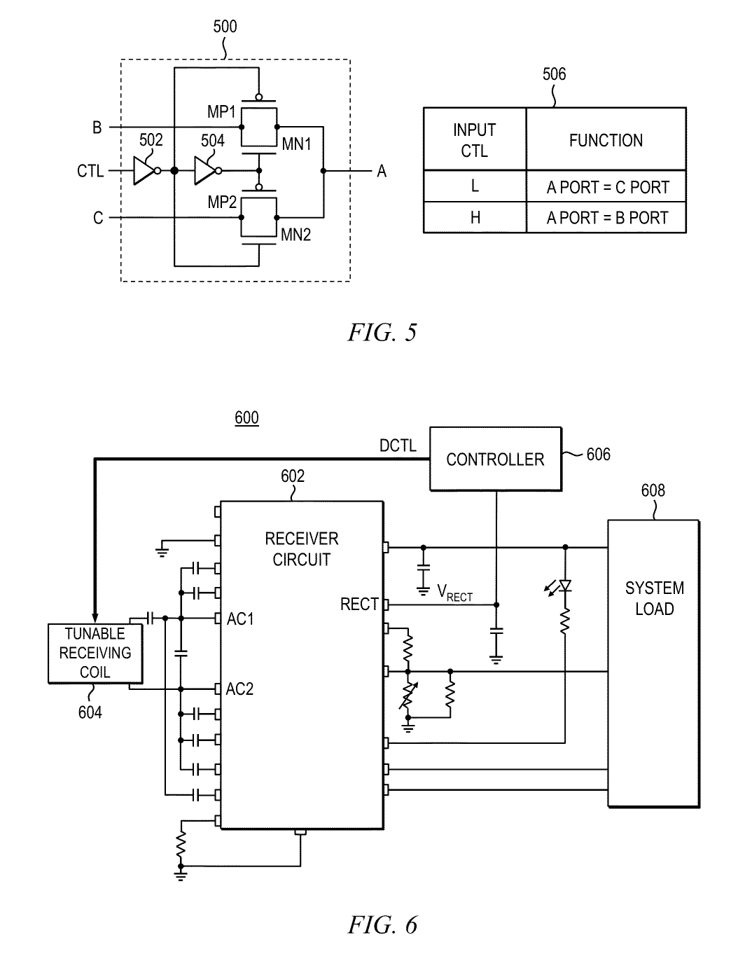

By way of example only and without limitation, FIG. 5 is a schematic diagram depicting at least a portion of exemplary switch circuit 500 for implementing each of at least a subset of the switches 414, 416, 418 and 420 shown in FIGS. 4A-4C, according to an embodiment of the invention. With reference to FIG. 5, the switch circuit 500 comprises a pair of transmission gates and a pair of inverters configured as a multiplexer. Specifically, a first transmission gate includes a PFET MP1 and an NFET MN1, and a second transmission gate includes a PFET MP2 and an NFET MN2. Drains of MP1 and MN1 are connected to a first port (A), sources of MP1 and MN1 are connected with a second port (B), a gate of MP1 is connected with an output of a first inverter 502, a gate of MN1 is connected with an output of a second inverter 504, the output of the first inverter 502 is connected with an input of the second inverter 504, and an input of the first inverter 502 is adapted to receive a control signal CTL supplied to the switch circuit 500. Likewise, drains of MP2 and MN2 are connected to the first port (A), sources of MP2 and MN2 are connected with a third port (C), a gate of MP2 is connected with the output of the second inverter 504, and a gate of MN2 is connected with the output of the first inverter 502.

It is to be appreciated that because a MISFET device is symmetrical in nature, and thus bi-directional, the assignment of source and drain designations in the MISFET device is essentially arbitrary. Therefore, the source and drain of a given MISFET device may be referred to herein generally as first and second source/drain, respectively, where “source/drain” in this context denotes a source or a drain.

The switch circuit 500 is configured to electrically connect port A to either port B or port C as a function of a logical state of the control signal CTL. As shown in truth table 506, when control signal CTL is at a logic low level (e.g., VSS or zero volt), port A is connected with port C; when CTL is a logic high level (e.g., VDD or 3.3 volts), port A is connected with port B. When the switching circuitry includes a plurality of switch circuits, each switch circuit controlling the current flow in a corresponding conductive loop of the receiving coil, a control signal in the form of a digital word can be used for selectively tuning the center of the receiving coil, as will become apparent to those skilled in the art given the teachings herein.

In one or more embodiments of the invention, the control signal for selectively tuning an electrical center of the receiving coil, to thereby increase an amount of energy induced in the receiving coil from the EM field, is generated by a microprocessor or alternative controller coupled with the receiving coil. In order to determine which combination of switches to set for providing a more favorable adjustment (i.e., tuning) of the receiving coil, the controller is configured to measure a magnitude of the voltage induced in the receiving coil from the EM field. In this regard, the controller, in one or more embodiments, is configured to receive a signal, generated by a voltage detector or alternative monitor circuit, which is indicative of an amount of energy transferred to the receiving coil from the EM field. The monitor circuit may reside externally to the controller or, in one or more alternative embodiments, at least a portion of the monitor circuit may be incorporated within the controller.

In one or more embodiments, the receiving coil adjustment process is performed once, such as, for example, during an initial calibration procedure conducted by the controller, and the switch combination determined to provide a more optimal transfer of energy from the EM field is used throughout the operation of the energy transfer system. Alternatively, in one or more other embodiments, the receiving coil adjustment process is performed multiple times, such as, for example, at prescribed time intervals or whenever an energy transfer efficiency falls below a prescribed threshold (e.g., as measured during operation of the system), so as to provide a more optimal transfer of energy from the EM field on-the-fly, which is especially advantageous when the device being powered or charged is moving in relation to the EM field source.

With reference now to FIG. 6, a schematic diagram depicts at least a portion of an exemplary wireless inductive power system 600, according to an embodiment of the invention. The system 600 includes a wireless power transfer receiver circuit 602, a tunable receiving coil 604 connected with the receiver circuit, and a controller 606 connected with the receiving circuit and tunable receiving coil. The controller 606 is connected with the receiver circuit 602 and receiving coil 604 in a closed-loop feedback configuration. Also shown in FIG. 6 is a system load 608, which represents a down-system electronic device to be powered from or charged by an EM field (not explicitly shown, but implied) in proximity to the receiving coil 604.

In this illustrative embodiment, the receiver circuit 602 is implemented using manufacturer part number bq5101x, commercially available from Texas Instruments Inc., or equivalent. It is to be understood, however, that embodiments of the invention are not limited to any specific receiver circuit implementation. Moreover, embodiments of the invention are not limited to using the receiver circuit 602 as a means for detecting/decoding the radiated signal; rather, alternative detection and/or decoding means are similarly contemplated in accordance with embodiments of the invention, including integration at least a portion of the monitor circuit with the controller 606, as previously stated. As apparent from FIG. 6, the receiver circuit 602 includes two input pins, AC1 and AC2, adapted for connection with the receiving coil 604. The receiver circuit 602 includes rectification circuitry (not explicitly shown, but implied) which is configured to receive an AC current induced in the receiving coil 604 from the EM field and to convert the induced AC current into a rectified voltage, V_{RECT}, which is supplied as an output on pin RECT.

A larger AC current induced in the receiving coil 604 will translate into a larger rectified output voltage V_{RECT}. In turn, a larger induced current in the receiving coil 604 is presumed to evidence a more optimal alignment of the receiving coil with the corresponding EM field for increased energy transfer. Therefore, by monitoring the voltage V_{RECT} on pin RECT of the receiver circuit 602, the controller 606 can indirectly measure a level of the induced AC current in the receiving coil 604, and thereby determine a more optimal setting of the switching circuitry in the receiving coil. In one or more embodiments, the controller 606 steps through each combination, or at least a subset of the total number of combinations, of switch configurations in the receiving coil 604 (i.e., individually activates a selected switch combination during a given evaluation cycle), and measures the rectified voltages V_{RECT} corresponding to those switch configurations. For a coarser adjustment of the receiving coil 604, the controller 606, in one or more embodiments, is configured to test only a prescribed subset of the available switch configurations (e.g., every other combination) in the receiving coil, while for a finer adjustment procedure, the controller may test a greater number of switch configurations. The finer the adjustment process desired, the more time is required to complete the adjustment procedure.

The controller 606, in one or more embodiments, is configured to store (e.g., in a look-up table or alternative storage element), for each switch configuration, a value of the corresponding measured voltage V_{RECT}. The storage element in which one or more values of the measured voltage V_{RECT} are stored, may be embedded within the controller 606 or, alternatively, may reside externally with respect to the controller. The measured voltage amplitude may be directly stored or, alternatively, a value (e.g., a digital word, count value, etc.) indicative of the measured voltage may be stored. For example, in one or more embodiments, the controller 606 includes an analog-to-digital converter (not explicitly shown, but implied) configured to convert a measured analog rectified voltage VRECT and to convert this analog voltage into a digital representation thereof. The controller 606, in one or more embodiments, is further configured to compare the stored voltage values and to generate a control signal, which may be in the form of a digital control word, DCTL, which configures the switches in the receiving coil 604 to produce the largest voltage among the plurality of tested switch configurations. To facilitate the comparison process, the controller 606 may employ one or more known algorithms, for example, a successive approximation or similar methodology (e.g., Newton-Raphson method, Aitken delta-squared process, gradient descent, etc.), as will become apparent to those skilled in the art.

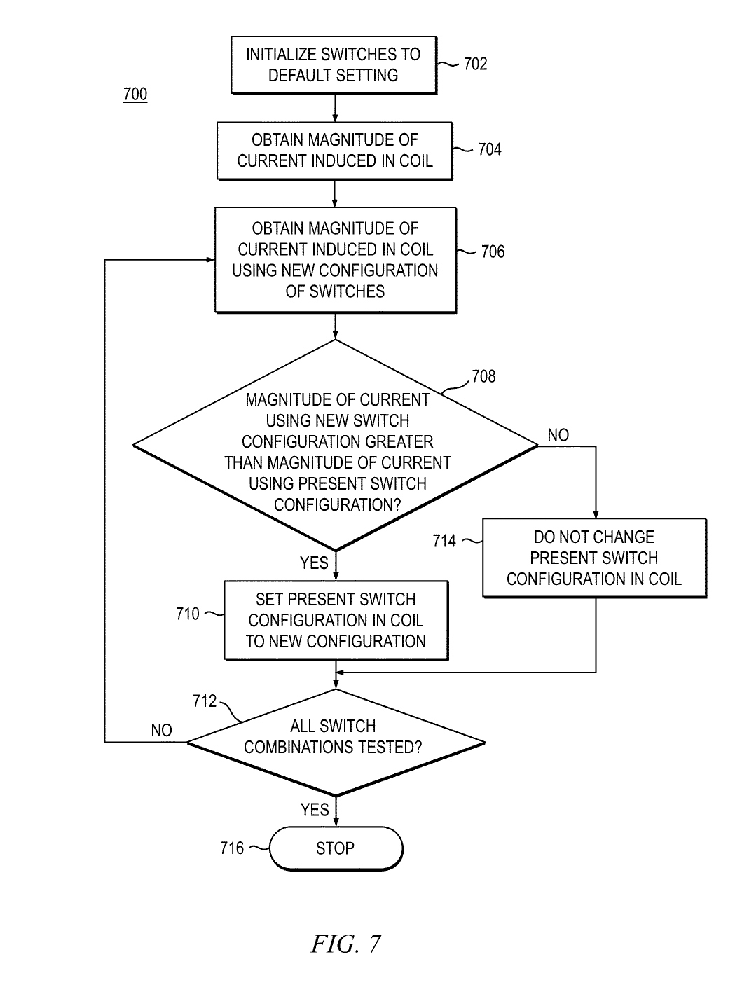

FIG. 7 is a flow diagram depicting an exemplary methodology 700 for configuring at least a subset of switches in a receiving coil apparatus, according to one or more embodiments of the invention. With reference to FIG. 7, the illustrative method 700, in step 702, performs an initialization in which all, or a subset, of switches in the receiving coil apparatus are set to a prescribed (e.g., default or initial) configuration. This initial configuration is used as a present switch configuration for the receiving coil apparatus. In step 704, a magnitude of the current induced in the receiving coil is obtained, such as by measuring a rectified voltage or other parameter indicative of the induced current in the coil. An illustrative system and methodology for detecting the rectified voltage, in accordance with one or more embodiments of the invention, was previously described in conjunction with FIG. 6. Optionally, the measured magnitude of the induced current in the coil with the switch set to their present configuration is stored for subsequent comparison.

Once the magnitude of the induced current in the receiving coil with the switches set to the present configuration has been obtained in step 704, the magnitude of the induced current using a new and different switch configuration from the present configuration is obtained in step 706. Optionally, the measured magnitude of the induced current in the coil using the new switch configuration is stored for subsequent comparison. Illustrative algorithms for determining a next switch configuration to test have been previously discussed, details of which will become apparent to those skilled in the art given the teachings herein.

A comparison is made in step 708 between the value of the induced current using the present switch configuration and the value of the induced current using the new switch configuration. When the magnitude of the induced current using the new switch configuration is greater than the magnitude of the induced current using the present configuration of the switches, the switches are set to the new configuration in step 710, and the method 700 proceeds to step 712. Alternatively, when the magnitude of the induced current using the new switch configuration is not greater than the magnitude of the induced current using the present configuration of the switches, as determined in step 708, the switches are left in their present configuration in step 714, and the method 700 proceeds to step 712.

When, in step 712, it is determined that there remain any combinations of switch configurations for the receiving coil that have the potential of producing more favorable results, at least in terms of determining a local peak of the induced current, that have not yet been tested, the method 700 reverts to step 706 where the comparison procedure is repeated. Otherwise, when all desired switch configurations have been tested so that a local peak of the induced current in the receiving coil is found, the method 700 is stopped at step 716. A local peak of the induced current is found, in one or more embodiments, by determining a point at which a change in direction of the magnitude of the induced current (e.g., from increasing current to decreasing current) is detected, at which point it is assumed that a localized peak in the induced current has been passed.

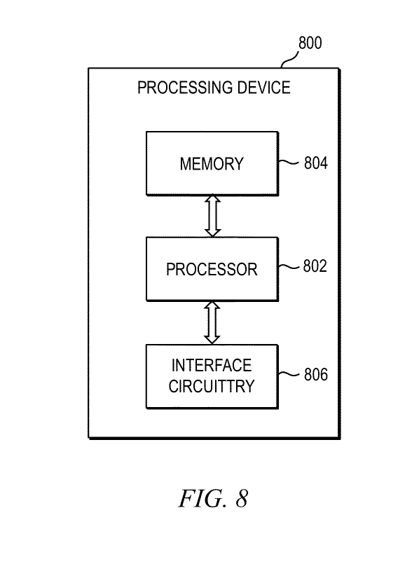

FIG. 8 is a block diagram depicting an exemplary processing device 800 suitable for implementing at least a portion of the illustrative controller 606 shown in FIG. 6, according to an embodiment of the invention. The processing device 800 includes a processor 802 and memory 804 coupled with the processor. The processing device 800 further includes interface circuitry 806 coupled with the processor 802. The memory 804 may comprise, for example, a look-up table, registers, memory array, etc., adapted to store information used by the processor 802 in performing voltage detection and/or switch selection methodologies according to embodiments of the invention. The interface circuitry 806 may comprise, for example, an analog-to-digital converter, counter, latch, sample-and-hold circuit, etc., as may be necessary or helpful to the processor 802 in performing the voltage detection and/or switch selection methodologies according to embodiments of the invention. The processing device 800 may comprise, for example, a computer, microcontroller, state machine, etc., configured to perform one or more methodologies in accordance with embodiments of the invention.

In an integrated circuit implementation of one or more embodiments of the invention, multiple identical die are typically fabricated in a repeated pattern on a surface of a semiconductor wafer. Each such die may include a device described herein, and may include other structures and/or circuits. The individual dies are cut or diced from the wafer, then packaged as integrated circuits. One skilled in the art would know how to dice wafers and package die to produce integrated circuits. Any of the exemplary circuits illustrated in the accompanying figures, or portions thereof, may be part of an integrated circuit. Integrated circuits so manufactured are considered part of this invention.

The illustrations of embodiments of the invention described herein are intended to provide a general understanding of the structure of various embodiments, and they are not intended to serve as a complete description of all the elements and features of apparatus and systems that might make use of the structures described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the invention are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The abstract is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Written Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus the following claims are hereby incorporated into the Written Description, with each claim standing on its own as separately claimed subject matter.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

What is claimed is:

1. A receiving coil apparatus for use in an electromagnetic energy transfer system, the receiving coil apparatus comprising:
a plurality of conductive loops;
a switching circuit connected with the plurality of conductive loops, the switching circuit being configured to control an electrical center of the receiving coil apparatus as a function of at least one control signal; and
a controller coupled with the switching circuit, the controller being configured to generate the at least one control signal for controlling an alignment of the electrical center of the receiving coil apparatus with an electromagnetic field so as to enhance an amount of energy transferred to the receiving coil apparatus from the electromagnetic field.

2. The apparatus of claim 1, wherein the switching circuit is configured to selectively steer a flow of current, induced from the electromagnetic field, in at least a subset of the plurality of conductive loops as a function of the at least one control signal to thereby control the electrical center of the receiving coil apparatus.

3. The apparatus of claim 1, wherein the switching circuit comprises a plurality of switches, each of the switches being connected in series with a conductive segment in a corresponding one of the conductive loops, each given one of the switches being configured to steer current in a corresponding conductive segment with which the given switch is connected to a different conductive segment in another one of the conductive loops.

4. The apparatus of claim 3, wherein at least one of the plurality of switches comprises first and second transmission gates, a first connection node of the first and second transmission gates being connected with a first node of the conductive segment in the corresponding one of the conductive loops, a second connection node of the first transmission gate being connected with a second node of the conductive segment in the corresponding one of the conductive loops, a second connection node of the second transmission gate being connected with the different conductive segment in another corresponding one of the conductive loops, a control input of the first transmission gate being configured to receive the at least one control signal, and a control input of the second transmission gate being configured to receive a logical complement of the at least one control signal, the at least one switch being configured in a first mode to electrically connect the first and second nodes of the conductive segment in the corresponding one of the conductive loops and to electrically disconnect the different conductive segment from another one of the conductive loops, and the at least one switch being configured in a second mode to electrically disconnect the first and second nodes of the conductive segment in the corresponding one of the conductive loops and to electrically connect the first node of the conductive segment in the corresponding one of the conductive loops with the different conductive segment in another one of the conductive loops, a mode of the at least one switch being controlled as a function of the at least control signal.

5. The apparatus of claim 3, wherein a given one of the switches in the switching circuit is configured to steer current in the corresponding one of the conductive loops in which the given one of the switches is connected to an adjacent conductive loop.

6. The apparatus of claim 3, wherein a given one of the switches in the switching circuit is configured to steer current in the corresponding one of the conductive loops in which the given one of the switches is connected to a non-adjacent conductive loop.

7. The apparatus of claim 3, wherein the controller is configured to individually activate each of at least a subset of a total number of combinations of switch configurations in the switching circuit, and to measure respective values indicative of amounts of energy induced in the receiving coil apparatus from the electromagnetic field corresponding to the at least a subset of the total number of combinations of switch configurations.

8. The apparatus of claim 7, wherein the controller is further configured to store the respective values indicative of amounts of energy induced in the receiving coil apparatus corresponding to the at least a subset of the total number of combinations of switch configurations.

9. The apparatus of claim 7, wherein the at least one control signal generated by the controller is adapted to select a given one of the combinations of switch configurations which corresponds to a maximum value among the measured respective values indicative of amounts of energy induced in the receiving coil apparatus.

10. The apparatus of claim 3, wherein the controller is configured: (i) to set the switches in the switching circuit to an initial configuration, the initial configuration representing a present configuration of the switches; (ii) to obtain a magnitude of current induced in the receiving coil apparatus corresponding to the present configuration; (iii) to obtain a magnitude of current induced in the receiving coil apparatus using a new and different switch configuration from the present configuration; (iv) to compare the magnitude of current induced in the receiving coil apparatus using the present switch configuration with the magnitude of current induced in the receiving coil apparatus using the new switch configuration; (v) to set the present configuration to the new configuration when the magnitude of current induced in the receiving coil apparatus using the new switch configuration is greater than the magnitude of current induced in the receiving coil apparatus using the present configuration; (vi) to leave the switches in the present configuration when the magnitude of current induced in the receiving coil apparatus using the new switch configuration is not greater than the magnitude of current induced in the receiving coil apparatus using the present configuration; and (vii) to repeat steps (iii) through (vi) until all of at least the subset of possible switch configurations have been evaluated.

11. The apparatus of claim 10, wherein the controller is configured to determine, in an evaluation of at least the subset of possible switch configurations, a point at which a change in direction of the magnitude of current induced in the receiving coil apparatus is detected to thereby determine a local peak of the induced current in the receiving coil apparatus.

12. The apparatus of claim 1, wherein the controller is configured to receive a signal indicative of an amount of energy induced in the receiving coil apparatus from the electromagnetic field.

13. The apparatus of claim 1, wherein the controller comprises a monitor circuit configured to detect at least one of a voltage and a current indicative of an amount of energy induced in the receiving coil apparatus from the electromagnetic field.

14. The apparatus of claim 13, wherein the monitor circuit is configured to generate the at least one control signal as a function of a magnitude of the amount of energy induced in the receiving coil apparatus.

15. The apparatus of claim 13, wherein the monitor circuit comprises rectification circuitry, the rectification circuitry being configured to receive an alternating current induced in the receiving coil apparatus from the electromagnetic field and to convert the induced alternating current into a rectified voltage, an amplitude of the rectified voltage being indicative of the amount of energy induced in the receiving coil apparatus.

16. The apparatus of claim 1, wherein at least a portion of the receiving coil apparatus is fabricated in an integrated circuit.

17. An inductive charging system, comprising:
a primary device, the primary device including a first controller coupled with an alternating current power source and a transmitting coil coupled with the first controller, the transmitting coil generating an electromagnetic field which is controlled by the first controller; and
a secondary device, the secondary device including:
a receiving coil apparatus comprising:
a plurality of conductive loops;
a switching circuit connected with the plurality of conductive loops, the switching circuit being configured to control an electrical center of the receiving coil apparatus as a function of at least one control signal; and
a second controller coupled with the switching circuit, the second controller being configured to generate the at least one control signal for controlling an alignment of the electrical center of the receiving coil apparatus with the electromagnetic field so as to enhance an amount of energy transferred to the receiving coil apparatus from the electromagnetic field; and
a rectifier circuit connected with the receiving coil apparatus, the rectifier circuit being configured to receive an alternating current signal from the receiving coil apparatus and to convert the alternating current signal to a rectified output voltage.

18. The system of claim 17, wherein the switching circuit comprises a plurality of switches, each of the switches being connected in series with a conductive segment in a corresponding one of the conductive loops, each given one of the switches being configured to steer current in a corresponding conductive segment with which the given switch is connected to a different conductive segment in another one of the conductive loops.

19. The system of claim 18, wherein at least one of the plurality of switches comprises first and second transmission gates, a first connection node of the first and second transmission gates being connected with a first node of the conductive segment in the corresponding one of the conductive loops, a second connection node of the first transmission gate being connected with a second node of the conductive segment in the corresponding one of the conductive loops, a second connection node of the second transmission gate being connected with the different conductive segment in another corresponding one of the conductive loops, a control input of the first transmission gate being configured to receive the at least one control signal, and a control input of the second transmission gate being configured to receive a logical complement of the at least one control signal, the at least one switch being configured in a first mode to electrically connect the first and second nodes of the conductive segment in the corresponding one of the conductive loops and to electrically disconnect the different conductive segment from another one of the conductive loops, and the at least one switch being configured in a second mode to electrically disconnect the first and second nodes of the conductive segment in the corresponding one of the conductive loops and to electrically connect the first node of the conductive segment in the corresponding one of the conductive loops with the different conductive segment in another one of the conductive loops, a mode of the at least one switch being controlled as a function of the at least control signal.

20. The system of claim 17, wherein the switching circuit is configured to selectively steer a flow of current, induced from the electromagnetic field, in at least a subset of the plurality of conductive loops as a function of the at least one control signal to thereby control the electrical center of the receiving coil apparatus.

21. A method for enhancing energy transfer performance in an electromagnetic energy transfer system, the method comprising:
providing a receiving coil configured having an electrical center that is controllable as a function of at least one control signal;
determining an amount of energy induced in the receiving coil for each of a plurality of configurations of the electrical center of the receiving coil; and
generating the at least one control signal for controlling an alignment of the electrical center of the receiving coil relative to an electromagnetic field so as to enhance an amount of energy transferred to the receiving coil from the electromagnetic field.

22. The method of claim 21, wherein the step of generating the at least one control signal comprises:
detecting at least one of a voltage and a current indicative of an amount of energy induced in the receiving coil from the electromagnetic field for each of the plurality of configurations of the electrical center of the receiving coil; and
determining a selected configuration of the electrical center of the receiving coil corresponding to at least one of a voltage and a current indicative of a greater amount of energy induced in the receiving coil from among the plurality of configurations.

23. The method of claim 22, wherein controlling the alignment of the electrical center of the receiving coil relative to the electromagnetic field comprises selectively steering a flow of current, induced from the electromagnetic field, in at least a subset of a plurality of conductive loops in the receiving coil as a function of the at least one control signal to thereby control the electrical center of the receiving coil.
